(19) United States
(12) Patent Application Publication
(10) Pub. No.: US 2007/0121220 A1
(43) Pub. Date: May 31, 2007

(54) Method for designing and fabricating optical lens unit

(75) Inventors: Hsiung Yu Tsai, Houlong Township (TW); Ching Sheng Chang, Taichung City (TW)

Correspondence Address: TROXELL LAW OFFICE PLLC;SUITE 1404, 5205 LEESBURG PIKE, FALLS CHURCH, VA, 22041, US

(73) Assignee: PowerGate Optical, Inc.

(21) Appl. No.: 11/494,595

(22) Filed: Jul. 28, 2006

(30) Foreign Application Priority Data
Nov. 29, 2005 (TW) 094141827

(51) Int. Cl. G02B 9/00

(52) U.S. Cl. 359/754

(57) ABSTRACT

A method for designing and fabricating lens unit comprises the steps of: establishing a set of known parameter values of a properly focused lens unit; inputting an image height desired; calculating a corresponding lens wall thickness and an air gap based on the image height inputted; and designing and fabricating a new lens unit based on the calculated lens wall thickness and air gap to accord with the image height inputted. As such, the present invention only needs to alter the wall thickness and air gap of optical lens to obtain different image heights. The alteration of wall thickness is achieved by adjusting the space between the male and female parts of the mold assembly; the alteration of air gap is achieved by providing a pad of predetermined thickness on the optical lens without the need to redesign the mold assembly for the fabrication of optical lens.

### BACKGROUND OF INVENTION

1. Field of the Invention

The present invention relates to a method for designing and fabricating optical lens unit, more particularly a method that can change the image height of optical lens unit without redesigning the mold assembly for the fabrication of optical lens.

2. Description of the Prior Art

As shown in FIG. 1, a standard camera 1 comprises a lens unit 11, a sensor 12 and a focusing mechanism (not shown in the figure). The lens unit 11 forms an image on sensor 12 (as shown in FIG. 1) by refracting the light rays from an object. The sensor 12 then converts the refracted light rays into electric signal for reading by a control unit (not shown in FIG. 1) and for it to carry out image processing.

In the design and fabrication processes of lens unit 11, customers oftentimes specify a special size for sensor 12, and at the same time a specific field of view (which is typically 60 degrees) for the camera 1. In such case, the lens designer and/or maker needs to design lens unit 11 according to the sensor 12 size and field of view instructed by customer. Sensors 12 presently available on the market come in a variety of sizes, and continue to evolve. The design and fabrication of lens unit 11 would take tremendous amount of manpower and money to meet customer specifications that results in waste of resources.

U.S. Pat. No. 6,859,233 and U.S. Pat. No. 6,301,061 disclose a lens that achieves focusing or zooming by switching lens of different thickness to optical path. But the prior art just mentioned uses “assembled” lens unit instead of disclosing the method for designing and fabricating a lens unit. In addition, prior art discloses technology that adjusts the focal length or magnifying power of lens unit on the “same” sensor, not technology that designs lens unit based on sensor of different sizes. In the focusing or zooming process, the prior art only considers the adjustment of lens thickness, but not the corresponding change of air gap between lenses. Moreover, the prior art did not disclose how to design and fabricate the lenses in lens unit to provide proper lens thickness and air gap. According to the prior art mentioned, it becomes necessary to redesign a brand new lens unit if one desires to change the size of sensor (e.g. changing the image height), which results in waste of resources.

### SUMMARY OF INVENTION

The object of the present invention is to provide a method for designing and fabricating a lens unit, which allows changing the image height of lens unit without redesigning the mold assembly for the production of optical lens.

In one preferred embodiment according to the present invention, a method for designing and fabricating lens unit comprises the steps of: establishing a set of known parameter values of a properly focused lens unit; inputting an image height desired; calculating a corresponding lens wall thickness and an air gap based on the image height input; and designing and fabricating a new lens unit based on the calculated lens wall thickness and air gap to accord with the image height inputted. As such, the present invention only needs to alter the wall thickness and air gap of optical lens to obtain different image heights. The alteration of wall thickness is achieved by adjusting the space between the male and female molds of the mold assembly; the alteration of air gap is achieved by providing a pad of predetermined thickness on the optical lens without the need to redesign the mold assembly for the fabrication of optical lens.

### BRIEF DESCRIPTION OF THE DRAWINGS

The details of the present invention will be more readily understood from a detailed description of the preferred embodiments taken in conjunction with the following figures.

FIG. 1 is a diagram showing the focusing principle of conventional lens.

FIG. 2 depicts the method for designing and fabricating a lens unit according to a preferred embodiment of the invention.

FIG. 3 is a diagram showing a known lens unit having a first image height according to the method for designing and fabricating lens unit of the invention.

FIG. 4 is a diagram showing a new lens unit having a second image height according to the method for designing and fabricating lens unit of the invention.

FIG. 5A and FIG. 5B are diagrams showing changing the lens wall thickness by shifting the gap between the male and female molds in a method for designing and fabricating lens unit according to the invention; wherein FIG. 5A is a diagram showing the female mold before shifting, while FIG. 5B is a diagram showing the female mold after shifting.

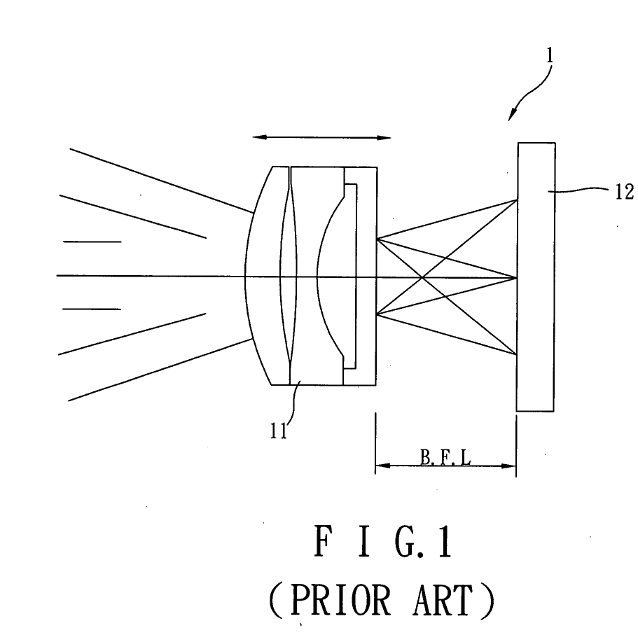

### DETAILED DESCRIPTION

The main principle of the method for designing and fabricating optical lens unit according to the present invention is to achieve image height adjustment to meet the customer specification of sensor size by changing the wall thickness and air gap of at least one lens in a lens unit without changing the field of view. Because changing the lens wall thickness may be achieved by adjusting the gap between the male and female parts of the mold assembly, while changing the air gap may be achieved by disposing a pad with predetermined thickness on the lens, there is no need to redesign the mold assembly for the production of lens. As such, the designer and manufacturer of optical lens unit can quickly design and fabricate optical lens unit according to customer specifications using available equipment and techniques. So the present invention offers the advantage of effective use of resources, and saves time, resources, and costs.

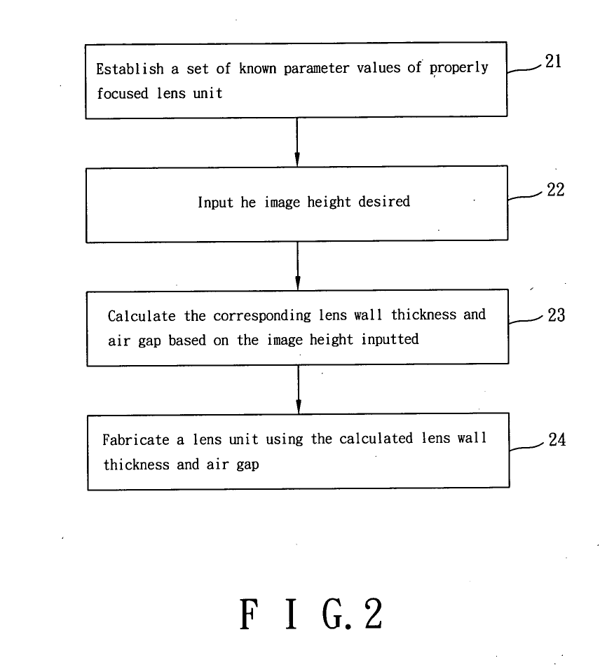

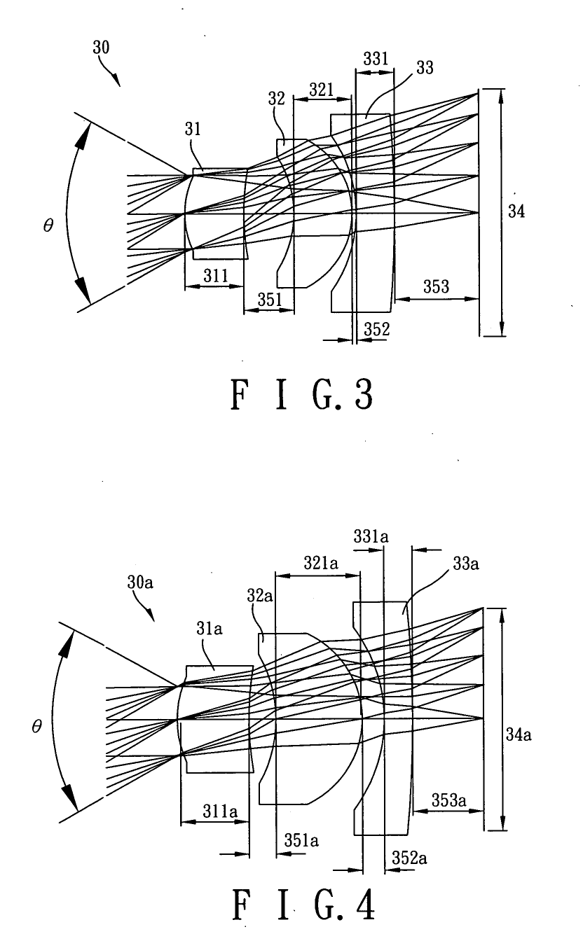

FIGS. 2-4 disclose a method for designing and fabricating optical lens unit according to a preferred embodiment of the invention. FIG. 2 shows the flow process of the method for designing and fabricating optical lens unit according to a preferred embodiment of the invention. FIG. 3 is a diagram showing a known lens unit having a first image height according to the method for designing and fabricating lens unit of the invention. FIG. 4 is a diagram showing a known new lens unit having a second image height according to the method for designing and fabricating lens unit of the invention.

As shown in FIG. 2, the method for designing and fabricating optical lens unit of the invention comprises the steps of:

Step 21: Establishing a set of known parameter values of a properly focused lens unit. Optical lens unit designers and manufacturers can employ the known parameter values of an existing first lens unit 30 that has been properly focused to create a set of optical functional equations. In this embodiment as shown in FIG. 3, the known first lens unit 30 consists of three optical lenses 31, 32, 33. The set of functional equations contains a plurality of parameter values to manifest the corresponding relations between parameters, and said plurality of parameter values contain at least an image height 34 (first image height), an air gap 351, 352, 353 (first air gap) anterior and posterior to the lens, and a wall thickness of the lenses 311, 321, 331 (first lens wall thickness), refractive index of lens material, and lens curvature.

Step 22: Inputting a new image height 34a desired. The new image height 34a (second image height) desired is determined based on customer's instructions for the field of view θ of new lens unit 30a and sensor size.

Step 23: Calculating the corresponding lens wall thickness 311a, 321a, 331a and air gap 351a, 352a, 353a according to the image height 34a input. Inputting the new image height 34a (second image height) into the functional equations and calculating the new parameter values corresponding to the new image height 34a. Those new parameter values contain at least a new lens wall thickness (one or more of new lens wall thickness 311a, 321a and 331a, called second lens wall thickness) of a lens (one or more of lens 31a, 32a, and 33a) and a new air gap (one or more of air gap 351a, 352a, and 353a, called second air gap). Other parameter values, including the number of lens 31a, 32a, 33a, and refractive index of lens material and curvature of lens 31a, 32a, 33a stay unchanged, that is, identical to the known parameter values of the properly focused first lens unit 30.

Step 24: Designing and fabricating a new lens unit 30a (second lens unit) as shown in FIG. 4 based on the new lens wall thickness 311a, 321a, 331a (second lens wall thickness) and new air gap 351a, 352a, 353a (second air gap) to accord with the new image height 34a inputted (second image height). In this embodiment, the known lens unit and the new lens unit have the same field of view θ, as well as the same number of lens, refractive index of lens material, and lens curvature.

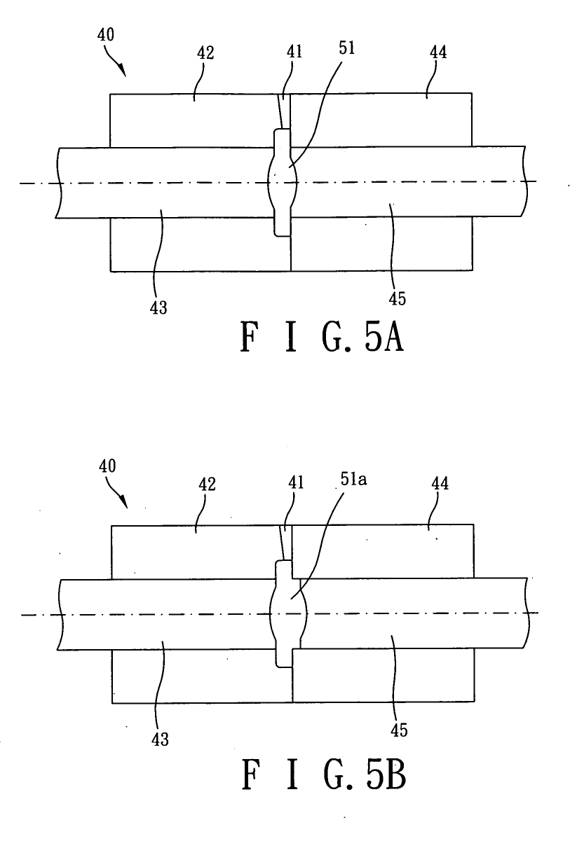

FIGS. 5A and 5B are diagrams showing changing the lens wall thickness by shifting the gap between the male and female molds according to the method for designing and fabricating lens unit of the invention. As shown in FIG. 5A, lenses 31, 32, 33, 31a, 32a, and 33a are generally fabricated by feeding a photopermeable material having predetermined refractive index into a mold assembly 40 through an inlet 41 and curing the material. The mold assembly 40 typically consists of a male mold frame 42, a male mold 43 disposed inside the male mold frame 42, a female mold frame 44, and a female mold 45 disposed inside the female mold frame 44. The male mold 43 and female mold 45 have respectively a predetermined curve design for the formation of optical lens with a predetermined curvature. The mold assembly 40 is formed with an accommodation space by closely matching the mold frames 42, 44 and molds 43, 45. Subsequently, photopermeable material with predetermined refractive index is fed into the accommodation space of the mold assembly 40 via the inlet 41. After the photopermeable material is cured, the mold assembly 40 is opened and an optical lens 51 is fabricated after the flashes are removed. The method for designing and fabricating lens unit according to the invention can achieve the objective of image height adjustment by changing the lens wall thickness without changing the lens curvature. Thus as shown in FIG. 5B, the method disclosed herein simply needs to adjust the gap between male mold and female mold (e.g. shifting the position of female mold 45 in female mold frame 44) to fabricate a new lens 51a that has a second lens wall thickness without the need to redesign a new mold assembly 40. In addition, a lens unit that conforms to the second air gap is fabricated by simply disposing a pad of predetermined thickness anterior or posterior to each lens to obtain the second air gap. As such, under the method disclosed herein, the designer and manufacturer of optical lens unit can quickly design and fabricate optical lens unit according to customer specifications using available equipment and techniques. So the present invention offers the advantage of effective use of resources, and saves time, resources, and costs.

The lens unit design method and the application of its optical functional equations are described using the known and new lens units shown in FIG. 3 and FIG. 4 as examples:

(A) Description of Lens Equations

First the basic optical functions of lens are introduced.

(a1) Single Lens:

For single lens, its optical function can be expressed as follows:
p=1/f=(N−1)((1/R1−1/R2)−(T/N)(1/R1R2)) (Eq. 1)
where f: Lens focal length
N: Refractive index of lens material
R1, R2: Radius of curvature of the front and back surfaces of lens
T: Material thickness

(a2) Lens Combination:

For a lens unit made of two optical lenses, its optical function can be expressed as follows:
P=1/F=(1/f1)+(1/f2)−(T/N)/f1f2 (Eq. 2)

where F: Effective focal length (EFL) of lens
f1, f2: Focal length of individual lens
N: Material between lenses
T: Distance between lenses

The equation for calculating the field of view (FOV) of the lens unit is:

$$FOV = 2 {tan}^{- 1} ( \frac{Y}{F} ) \qquad ( Eq . 3 )$$

where FOV: Field of view θ
Y: Image height of lens unit
F: Effective focal length of lens unit

By applying Eqs. 1˜3 above, the corresponding lens wall thickness and air gap may be determined by inputting the image height Y to achieve the basic object of the invention.

(B) First Preferred Embodiment of Optical Design:

Using the example of a known lens unit 30 and a new lens unit 30a shown in FIG. 3 and FIG. 4, the image height 34 of the known lens unit 30 is 4.28 mm, while the image height 34a of the new lens unit 30a is 3.26 mm.

To obtain the design where both lens units 30, 30a have FOV (θ)=60°, the new lens unit 30a can be fabricated by changing the lens wall thickness 311, 321, 331 and air gap 351, 352, 353 of one or more lenses 31, 32, 33 of lens unit 30. Below is the actual calculation:

(b1) First, the optical parameter values of the known lens unit 30 shown in FIG. 3 are as follows:

| Radius of curvature | Thickness (distance) | Glass | Taper |
|---|---|---|---|
| 1) 1.952283 | 0.9456778 | 1.617290, 60.4 | 0 |
| 2) 4.792914 | 0.8710841 | | 0 |
| *3) −5.789234 | 1.047581 | 1.729150, 46 | 7.42442 |
| *4) −0.9820674 | 0.05 | | −0.677571 |
| *5) −2.074632 | 0.6335389 | 1.755200, 27.5 | 0 |
| *6) 3.758542 | 1.472101 | | 0.8202025 |
| where the fields after 1) represent in sequence the radius of curvature of the anterior side (left side) of lens 31, lens thickness, refractive index of glass material, and taper (meaning spherical surface when taper is 0); | | | |
| # the fields after 2) represent in sequence the radius of curvature of the posterior side (right side) of lens 31, air gap, and taper; similarly the fields after 3) and 4) are respectively the parameter values of the anterior side (left side) and posterior side (right side) of lens 32; | | | |
| # and the fields after 5) and 6) are respectively the parameter values of the anterior side (left side) and posterior side (right side) of lens 33. | | | |

Where the fields with symbol * mean the curvature of the lens is non-spherical.

(b2) Non-spherical equation:

$$z = \frac{C {Y}^{2}}{1 + {( 1 - ( 1 + K ) {C}^{2} {Y}^{2} )}^{1 / 2}} + {A}_{4} {Y}^{4} + {A}_{6} {Y}^{6} + {A}_{8} {Y}^{8} + {A}_{10} {Y}^{10} + {A}_{12} {Y}^{12} + {A}_{14} {Y}^{14} \qquad ( Eq . 4 )$$

(b3) The anterior side (left side) of lens 32 has non-spherical curvature 3) with the following parameters:

A4: −0.1464671

A6: 0.01906334

A8: −0.051794802

A10: 0.013321277

A12: −0.015041165

A14: 0.025112377

(b4) The posterior side (right side) of lens 32 has non-spherical curvature 4) with the following parameters:

A4: 0.10882206

A6: −0.076525425

A8: 0.047715558

A10: −0.0088773685

A12: −0.011679214

A14: 0.0066098526

(b5) The anterior side (left side) of lens 33 has non-spherical curvature 5) with the following parameters:

A4: 0.0094098806

A6: 0.007037218

A8: 0.0014927784

A10: 0.00042425485

A12: −0.0014030275

A14: 0.00048301552

(b6) The posterior side (right side) of lens 33 has non-spherical curvature 6) with the following parameters:

A4: −0.089751199

A6: 0.017376604

A8: −0.0021373213

A10: −4.3719006e-005

A12: −0.00015420277

A14: 4.6647217e-005

(b7) Based on the optical parameters and functions of know lens unit 30 described above and by inputting the new image height 3.26 mm, the parameter values of new lens unit 30a as shown in FIG. 4 may be obtained from functional equations Eqs. 1˜4:

| Radius of curvature | Thickness (distance) | Glass | Taper |
|---|---|---|---|
| 1) 1.952283 | 1 | 1.617290, 60.4 | 0 |
| 2) 4.792914 | 0.3820041 | | 0 |
| *3) −5.789234 | 1.242992 | 1.729150, 46 | 7.42442 |
| *4) −0.9820674 | 0.3089046 | | −0.677571 |
| *5) −2.074632 | 0.39 | 1.755200, 27.5 | 0 |
| *6) 3.758542 | 1 | | 0.8202025 |

where the fields with symbol * mean the curvature of the lens is non-spherical. Given the non-spherical parameter values of the lenses of new lens unit 30a shown in FIG. 4 are completely identical to those of known lens unit 30, they will not be reiterated here.

As described above, among the parameter values of known lens unit 30 (FIG. 3) and new lens unit 30a (FIG. 4), only lens wall thickness (thickness) and air gap (distance) between lenses differ, while the rest of parameter values are identical. From Eqs. 1˜3, it is known that for known lens unit 30, EFL=3.7 mm, FOV=60°, whereas for the new lens unit 30a, EFL=2.8 mm and FOV=60°.

(C) Second Preferred Embodiment of Optical Design:

Below is another preferred embodiment that illustrates the simplified application of the lens unit design method according to the invention and its functional equations.

Again a known lens unit 30 and a new lens unit 30a having three lenses 31, 32, 33 similar to those shown in FIG. 3 and FIG. 4 are used as example. However, the actual shapes and sizes of lenses 31, 32, 33 in the second preferred embodiment might differ from those shown in FIG. 3 and FIG. 4. Assuming in this simplified embodiment, the image height of known lens unit 30 is 4.28 mm, that is, it is suitable for 4.28 mm sensor. When a customer makes an order, requesting a new lens unit 30a having a sensor size applicable to image height of 3.26 mm (assuming the FOV of the new lens unit stays unchanged at 60 degrees as the known lens unit), we can design the new lens unit 30a following the steps below:

(c1) First the optical parameters of the known lens unit 30 similar to that shown in FIG. 3 are depicted below: (the units of D, EFL, and AIR are in mm):

| | | | Known lens |
|---|---|---|---|
| First lens 31 | Second lens 32 | Third lens 33 | unit 30 |
| N1 = 1.61729 | N2 = 1.72915 | N3 = 1.7552 | Image |
| | | | height = |
| | | | 4.28 mm |
| R11 = 1.952283 | R21 = −5.789234 | R31 = −2.074632 | EFL = 3.7 |
| R12 = 4.792914 | R22 = −0.982067 | R32 = 3.758542 | AIR1 = |
| | | | 0.8710841 |
| D1 = 0.945678 | D2 = 1.047581 | D3 = 0.6335389 | AIR2 = 0.05 |

In the above table, N1, N2, and N3 represent respectively the refractive index of lens material 31, 32, and 33; R11, R21, and R31 represent respectively the radius curvature of the posterior side (right side) of lens 31, 32, and 33; D1, D2; and D3 represent respectively the thickness of lens 31, 32, and 33; EFL is the effective focal length of known lens unit 30; AIR1 is the air gap between the first lens 31 and the second lens 32; and AIR2 is the air gap between the second lens 32 and the third lens 33.

The parameter values of known lens unit 30 depicted in the above table are commonly used by lens manufacturers for lens design.

(c2) Calculating EFL of new lens unit 30a:

Using Eq. 3, we can input the image height (3.26 mm) and FOV (60 degrees) requested by the customer for the new lens unit 30a and obtain the EFL of the new lens unit 30a to be 2.8 mm.

(c3) The new lens unit 30a needs to change at least the thickness of one lens or the value of an air gap to obtain a EFL of 2.8 mm in step (c2):

If we wish to change only the value of an air gap (e.g. AIR2) without changing the other parameters of the lens to obtain the result of 2.8 mm EFL for new lens unit 30a, we can substitute the parameter values of known lens unit 30 (except for AIR2) coupled with the new EFL of 2.8 mm into Eq. 1 and Eq. 2, and obtain a new AIR2 of 0.32150565 mm. As such, the optical parameters of the newly designed lens unit 30a are depicted in the table below:

| | | | Known lens |
|---|---|---|---|
| First lens 31a | Second lens 32a | Third lens 33a | unit 30a |
| N1 = 1.61729 | N2 = 1.72915 | N3 = 1.7552 | Image |
| | | | height = |
| | | | 3.26 mm |
| R11 = 1.952283 | R21 = −5.789234 | R31 = −2.074632 | EFL = 3.7 |
| R12 = 4.792914 | R22 = −0.982067 | R32 = 3.758542 | AIR1 = |
| | | | 0.8710841 |
| D1 = 0.945678 | D2 = 1.047581 | D3 = 0.6335389 | AIR2 = |
| | | | 0.32150565 |

By comparing the optical parameters of new lens unit 30a and known lens unit 30, it is clear that we only need to change the AIR1 of new lens unit 30a for it to work with a sensor 3.26 mm in size, instead of redesigning the lens or remaking the lens mold.

Similarly, if we wish to change the thickness of a certain lens in the new lens unit 30a to reduce the overall dimensions of new lens unit 30a, we can input those optical parameters we do not intend to change into Eq. 1 and Eq. 2 to obtain the corresponding thickness (D1) of the lens (e.g. first lens 31a) or lenses (e.g. three lenses 31a, 32a, 33a) we wish to change. Thus by changing the thickness of at least one lens or an air gap, we can obtain a new lens unit that is consistent with the new image height desired.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A method for designing optical lens unit, comprising the steps of:
establishing a set of known parameter values of a properly focused lens unit;
inputting an image height desired;
calculating at least one corresponding lens wall thickness or at least one corresponding air gap based on the image height inputted; and
designing a new lens unit based on the calculated lens wall thickness and air gap to accord with the image height inputted.

2. The method according to claim 1, wherein said lens unit consists of at least two lenses, and said known parameter values include at least the refractive index of lens material, the curvature of lens, the lens wall thickness and air gap, and the image height of lens unit.

3. The method according to claim 2, wherein the new lens unit designed has identical parameter values as the known parameter values of properly focused lens unit, except for the input image height and the calculated lens wall thickness or air gap.

4. The method according to claim 2, wherein each lens is respectively manufactured with a mold assembly; said mold assembly comprises at least a mold frame, a male mold and a female mold, and furthermore a lens that accords with the lens wall thickness is fabricated by simply adjusting the gap between the male mold and the female mold without redesigning a new mold assembly.

5. The method according to claim 2, wherein a lens unit that accords with said air gap is fabricated by simply arranging a pad of predetermined thickness between the lenses.

6. A method for designing optical lens unit, comprising the steps of:
establishing a set of optical functional equations based on a known first lens unit that has been properly focused, said set of optical functional equations comprising a plurality of parameter values to manifest the corresponding relations of parameter values, and said plurality of parameter values consisting of at least a first image height, a first lens wall thickness, and a first air gap;
selecting a new parameter value desired, said new parameter value consisting of at least one of the following values: a second image height, a second lens wall thickness, and a second air gap;
inputting the new parameter value desired into the set of optical functional equations to calculate other corresponding parameter values; and
designing a second lens unit based on said new parameter value and the other parameter values calculated to accord with the new parameter value inputted.

7. The method according to claim 6, wherein the values of the first image height and the second image height are different, while the first lens unit and the second lens unit have the same field of view.

8. The method according to claim 6, wherein the new parameter value is the second image height, and the corresponding second lens wall thickness and second air gap are calculated using the set of optical functional equations, while the other parameter values of the second lens unit are identical to those of the first lens unit.

9. The method according to claim 8, wherein the first lens unit comprises at least two optical lenses and said parameter values further include the refractive index of each lens material and lens curvature.

10. The method according to claim 9, wherein each optical lens is respectively manufactured with a mold assembly; said mold assembly comprises at least a mold frame, a male mold and a female mold, and a lens that accords with a second lens wall thickness is fabricated by simply adjusting the gap between the male mold and the female mold without redesigning a new mold assembly.

11. The method according to claim 9, wherein the second lens unit that accords with the second air gap is fabricated by simply arranging a pad of predetermined thickness between the lenses.

12. A method for fabricating lens unit, comprising the steps of:
establishing a known lens unit that has been properly focused, said lens unit comprising at least a first optical lens able to focus light rays to clearly form an image having a first image height, said first optical lens having at least a first lens wall thickness and a first air gap, wherein the corresponding relations between the aforesaid values being expressed by a set of functional equations and said first optical lens being fabricated with a mold assembly, said mold assembly comprising at least a mold frame, a male mold, and a female mold, wherein the gap between the male mold and the female mold corresponds to the first lens wall thickness;
inputting a second image height desired;
calculating at least a second lens wall thickness and a second air gap of the first optical lens based on the second image height inputted;
shifting the gap between the male mold and the female mold to correspond to the new lens wall thickness, and then using the mold assembly with the gap between its male and female molds shifted to fabricate a new optical lens having a second wall thickness; and
replacing the first optical lens in the known lens unit with the new lens and repositioning the new lens unit to accord with the second air gap, and thereby fabricating a second lens unit able to focus light and form a clear image having a second image height.

13. The method according to claim 12, wherein the second lens unit having the second air gap is fabricated by simply arranging a pad having a predetermined thickness to the new lens.
